(19) United States
(12) Patent Application Publication
(10) Pub. No.: US 2021/0119340 A1
(43) Pub. Date: Apr. 22, 2021

(54) ANTENNA APPARATUSES AND IMAGE TRANSMISSION DEVICES HAVING SAME

(71) Applicant: SZ DJI TECHNOLOGY CO., LTD., Shenzhen (CN)

(72) Inventors: Xiaoqing SANG, Shenzhen (CN); Lu YE, Shenzhen (CN); Dong LI, Shenzhen (CN); Yiqing CHEN, Shenzhen (CN)

(73) Assignee: SZ DJI TECHNOLOGY CO., LTD., Shenzhen (CN)

(21) Appl. No.: 17/133,410

(22) Filed: Dec. 23, 2020

Related U.S. Application Data
(63) Continuation of application No. PCT/CN2019/087014, filed on May 15, 2019.

(51) Int. Cl. H01Q 13/08; H01P 5/08; H01Q 1/12

(52) U.S. Cl. CPC H01Q 13/08; H01Q 1/12; H01P 5/08

(57) ABSTRACT

An antenna apparatus and an image transmission device having the antenna apparatus are provided. The antenna apparatus includes a coaxial cable and an antenna assembly. The antenna assembly includes a housing, an antenna support, and an antenna. The antenna includes a pad disposed on the antenna support. The housing includes a first housing and a second housing, an accommodating space is formed by the first housing covering and engaging with the second housing, and the antenna support is accommodated in the accommodating space. A mounting hole is provided on the first housing, the mounting hole is in communication with the accommodating space, the coaxial cable is disposed through and fixed in the mounting hole, one end of the coaxial cable is accommodated in the accommodating space, and another end of the coaxial cable is exposed from the housing.

### RELATED APPLICATIONS

This application is a continuation application of PCT application No. PCT/CN2019/087014, filed on May 15, 2019, and the content of which is incorporated herein by reference in its entirety.

### TECHNICAL FIELD

The present disclosure relates to the antenna field, and in particular, to an antenna apparatus and an image transmission device having the same.

### BACKGROUND

A conventional antenna housing is generally fixed by using a buckle or a screw. Firstly, the buckle increases a housing size and lacks reliability when dropped, and is subject to a risk of falling off. Secondly, although the screw used for fixing the housing can have a fastening effect, the metal screw may affect performance of an antenna. In addition, these two conventional manners of fixing with a buckle or a screw may increase an overall structural weight and thus are not suitable for a weight-sensitive device, for example, a traversing vehicle dedicated to racing.

For a traversing vehicle, because it is usually used for racing, collisions and drops may frequently occur during operation of the traversing vehicle. However, a conventional laser-direct-structuring (LDS) antenna support is usually fixed on a housing. In the case where the housing is damaged, an LDS pad may also be damaged. Therefore, the conventional fixing manners can be hardly applicable to scenarios such as height drops and frequent collisions.

### SUMMARY

The present disclosure provides an antenna apparatus and an image transmission device having the same.

Specifically, the present disclosure is implemented through the following technical solutions:

According to a first aspect of the present disclosure, an antenna apparatus is provided, including: a coaxial cable including a cable core, a first insulating layer wrapping over the cable core, a shielding layer wrapping over the first insulating layer, and a second insulating layer wrapping over the shielding layer; and an antenna assembly including: a housing, including a first housing and a second housing, where an accommodating space is formed by the first housing covering and engaging with the second housing, an antenna support, accommodated in the accommodating space, and an antenna, disposed on the antenna support through laser-direct-structuring (LDS), and including a pad disposed on the antenna support, where the second housing includes a flange, the first housing connects to the flange and includes a mounting hole in communication with the accommodating space, the coaxial cable is disposed through and fixed in the mounting hole, one end of the coaxial cable is accommodated in the accommodating space, and the other end of the coaxial cable is exposed from the housing, where a corresponding end of the cable core couples with the pad to form an electrical connection between the coaxial cable and the antenna.

According to a second aspect of the present disclosure, an image transmission device is provided, including: a signal transceiver; and an antenna apparatus in cooperation with the signal transceiver to transmit and receive electromagnetic wave signals; the antenna apparatus including: a coaxial cable including a cable core, a first insulating layer wrapping over the cable core, a shielding layer wrapping over the first insulating layer, and a second insulating layer wrapping over the shielding layer; and an antenna assembly including: a housing, including a first housing and a second housing, where an accommodating space is formed by the first housing covering and engaging with the second housing, an antenna support accommodated in the accommodating space, and an antenna, disposed on the antenna support through laser-direct-structuring (LDS), and including a pad disposed on the antenna support, wherein the first housing connects to the flange and includes a mounting hole in communication with the accommodating space, the coaxial cable is disposed through and fixed in the mounting hole, one end of the coaxial cable is accommodated in the accommodating space, and the other end of the coaxial cable is exposed from the housing, where a corresponding end of the cable core couples with the pad to form an electrical connection between the coaxial cable and the antenna.

According to a third aspect of the present disclosure, an antenna apparatus is provided, including: a coaxial cable including a cable core, a first insulating layer wrapping over the cable core, a shielding layer wrapping over the first insulating layer, and a second insulating layer wrapping over the shielding layer; and an antenna assembly including a housing, including a mounting hole and an accommodating space in communication with the mounting hole, an antenna support accommodated in the accommodating space and not in contact with an inner sidewall of the housing, and an antenna, disposed on the antenna support through laser-direct-structuring (LDS), and including a pad disposed on the antenna support, where the coaxial cable is disposed through and fixed in the mounting hole, one end of the coaxial cable is accommodated in the accommodating space, another end of the coaxial cable is exposed from the housing, and a corresponding end of the cable core is fixedly connected to the pad to form an electrical connection between the coaxial cable and the antenna.

It can be seen from the above technical solutions provided by the first and second aspects of the present disclosure, in the present disclosure, the housing is connected through an ultrasonic process, a buckle structure or a screw fixing post is spared, and the volume and weight are further reduced. This is advantageous for miniaturization and light-weight design of the antenna apparatus, and also reduces an impact of components such as a metal screw on performance of the antenna apparatus. In addition, the structure of the ultrasonic connection is tightly integrated, and has good drop resistance.

It can be seen from the above technical solutions provided by the third and fourth aspects of the present disclosure, in the present disclosure, the antenna support is not in contact with the inner sidewall of the housing; in addition, the pad is fixedly connected to the corresponding end of the cable core to fix the antenna support to the coaxial cable and implement an electrical connection between the antenna and the coaxial cable. In this way, the pad in the housing can be protected. Even if the housing receives an external impact force such as a drop, an impact, or a collision, the pad is not affected by the impact force. This improves drop resistance and reliability of the antenna apparatus. The antenna apparatus may be applied to a device used under a harsh operating condition, such as an unmanned aerial vehicle.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some exemplary embodiments of the present disclosure, and a person of ordinary skill in the art may still derive other drawings from these accompanying drawings without creative efforts.

FIG. 1 is an exploded schematic structural diagram of an antenna apparatus according to some exemplary embodiments of the present disclosure;

FIG. 2 is a structural block diagram of an antenna apparatus according to some exemplary embodiments of the present disclosure;

FIG. 3 is a cross-sectional view of an antenna apparatus according to some exemplary embodiments of the present disclosure;

FIG. 4 is a schematic diagram of part A of an antenna apparatus according to the exemplary embodiments shown in FIG. 3;

FIG. 5 is an exploded schematic diagram of an antenna assembly of an antenna apparatus according to some exemplary embodiments of the present disclosure;

FIG. 6 is a schematic structural diagram of a first housing of an antenna apparatus according to some exemplary embodiments of the present disclosure;

FIG. 7 is a schematic structural diagram of a first housing of an antenna apparatus in another direction according to some exemplary embodiments of the present disclosure;

FIG. 8 is a cross-sectional view of an antenna apparatus according to some exemplary embodiments of the present disclosure; and

FIG. 9 is a structural block diagram of an image transmission device according to some exemplary embodiments of the present disclosure.

### REFERENCE NUMERALS

100: signal transceiver; 200: antenna apparatus;

1: coaxial cable; 11: cable core; 12: first insulating layer; 13: shielding layer; 14: second insulating layer;

2: antenna assembly; 21: housing; 211: first housing; 2111: mounting hole; 2112: ultrasonic wire; 2113: first connecting surface; 2114: second connecting surface; 2115: first protruding rib; 2116: groove; 212: second housing; 2121: flange; 21211: third connecting surface; 21212: fourth connecting surface; 22: antenna support; 221: main body portion; 222: sub-support; 223: second protruding rib; 224: third protruding rib; 23: antenna; 231: pad; 2311: fixing hole; 2312: welding hole; 24: accommodating space; 241: first cavity; 242: second cavity; 25: cushioning layer;

3: connector; 31: connecting hole; 32: first connecting end; 33: second connecting end; and

4: rivet member.

### DETAILED DESCRIPTION

Some exemplary embodiments of the present disclosure provides an antenna apparatus. The antenna apparatus may include a coaxial cable and an antenna assembly. The coaxial cable may include a cable core, a first insulating layer wrapping over the cable core, a shielding layer wrapping over the first insulating layer, and a second insulating layer wrapping over the shielding layer. The antenna assembly may include a housing, an antenna support, and an antenna provided on the antenna support through LDS. The antenna may include a pad disposed on the antenna support.

According to the exemplary embodiments of the present disclosure, a mounting hole and an accommodating space are provided for the housing, the antenna support is accommodated in the accommodating space, the mounting hole is in communication with the accommodating space, and the coaxial cable is disposed through and fixed in the mounting hole. In addition, one end of the coaxial cable is accommodated in the accommodating space, and the other end thereof is exposed from the housing.

In some examples, the housing may include a first housing and a second housing, an accommodating space is formed by the first housing covering and engaging with the second housing, and a mounting hole is provided in the first housing. Certainly, a structure of the housing is not limited to a combination of the first housing and the second housing, and may also be designed in another manner.

In some exemplary embodiments, a corresponding end of the cable core is engaged with the pad to implement an electrical connection between the coaxial cable and the antenna. Further, a flange is provided on the second housing, and the first housing is connected to the flange by ultrasonic welding to enable the first housing and the second housing to be fixed. Since the housing is connected through an ultrasonic process, a buckle structure or a screw fixing post is spared, and the volume and weight are further reduced. This is advantageous for miniaturization and light-weight design of the antenna apparatus, and also reduces an impact of components such as a metal screw on performance of the antenna apparatus. In addition, the structure of the ultrasonic connection is tightly integrated, and has good drop resistance.

In some exemplary embodiments, the antenna support is not in contact with an inner sidewall of the housing, and the corresponding end of the cable core is fixedly connected to the pad to implement an electrical connection between the coaxial cable and the antenna. According to the exemplary embodiments of the present disclosure, the antenna support is not in contact with the inner sidewall of the housing; in addition, the pad is fixedly connected to the corresponding end of the cable core to fix the antenna support to the coaxial cable and implement an electrical connection between the antenna and the coaxial cable. In this way, the pad in the housing can be protected. Even if the housing receives an external impact force such as a drop, an impact, or a collision, the pad is not affected by the impact force. This improves drop resistance and reliability of the antenna apparatus. The antenna apparatus may be applied to a device used under a harsh operating condition, such as an unmanned aerial vehicle.

The following clearly and fully describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the scope of protection of the present disclosure.

An antenna apparatus and an image transmission device having the antenna apparatus in the present disclosure will be hereinafter described in detail with reference to accompanying drawings. Under a condition that no conflict occurs, the features in the following embodiments and examples may be combined.

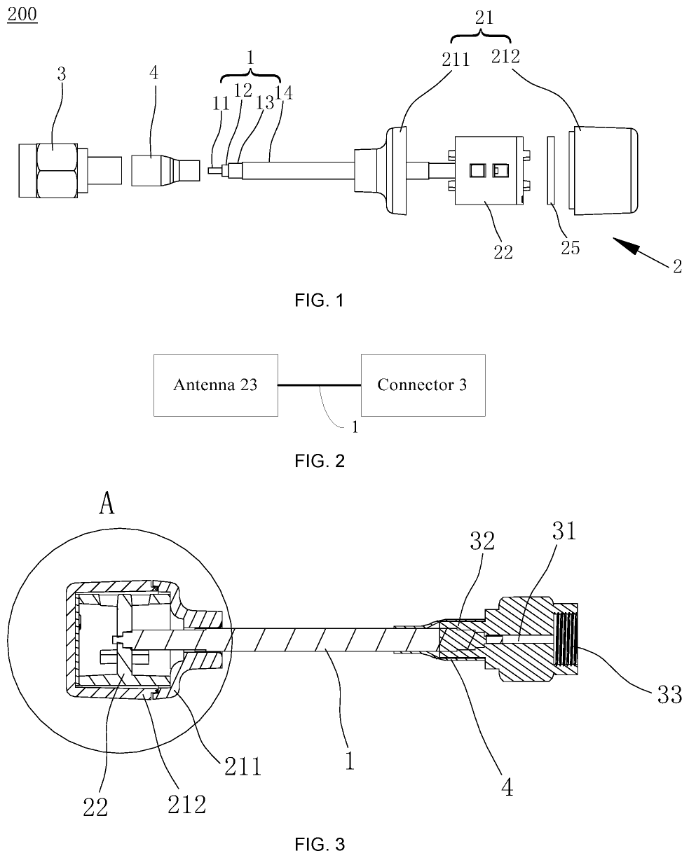

Exemplary embodiments with reference to FIG. 1 to FIG. 4 illustrate an antenna apparatus, where the antenna apparatus 200 may include a coaxial cable 1 and an antenna assembly 2. The coaxial cable 1 may include a cable core 11, a first insulating layer 12 wrapping over the cable core 11, a shielding layer 13 wrapping over the first insulating layer 12, and a second insulating layer 14 wrapping over the shielding layer 13. The shielding layer 13 in the exemplary embodiments of the present disclosure is a metal layer, and can strengthen and protect the cable core 11. With reference to FIG. 1 and FIG. 3, for the end portion of an end of the coaxial cable 1, the cable core 11 is exposed from the first insulating layer 12, the first insulating layer 12 is exposed from the shielding layer 13, and the shielding layer 13 is exposed from the second insulating layer 14.

The antenna assembly 2 may include a housing 21, an antenna support 22, and an antenna 23 provided on the antenna support 22 through LDS. The antenna 23 may include a pad 231 disposed on the antenna support 22. The housing 21 may include a first housing 211 and a second housing 212, an accommodating space 24 is formed and covered by the first housing 211 covering and engaging with the second housing 212, and the antenna support 22 is accommodated in the accommodating space 24. A mounting hole 2111 is provided in the first housing 211, the mounting hole 2111 is connected to the accommodating space 24, and the coaxial cable 1 is disposed through and fixed in the mounting hole 2111. In addition, one end of the coaxial cable 1 is accommodated in the accommodating space 24, and the other end of the coaxial cable 1 is exposed from the housing 21.

In the exemplary embodiments of the present disclosure, a corresponding end of the cable core 11 is engaged with the pad 231 to implement an electrical connection between the coaxial cable 1 and the antenna 23. Further, a flange 2121 is provided on the second housing 212, and a welded wire is connected to the flange 2121 by welding/soldering to enable the first housing 211 and the second housing 212 to be fixed. For example, the welded wire may be an ultrasonic wire 2112, which is connected to the flange 2121 by ultrasonic welding to enable the first housing 211 and the second housing 212 to be fixed. For illustration purpose, the welded wire may be described as ultrasonic wire in the present disclosure. However, one of ordinary skill in the art would understand that the welded wire may be welded/soldered by other means.

In the antenna apparatus 200 in the exemplary embodiments of the present disclosure, when the first housing 211 and the second housing 212 are not ultrasonic-welded, the ultrasonic wire 2112 is provided on the first housing 211, the flange 2121 is provided on the second housing 212, and the ultrasonic wire 2112 is connected to the flange 2121 by ultrasonic welding to enable the first housing 211 and the second housing 212 to be fixedly connected. Because the housing 21 is connected through an ultrasonic process, a buckle structure or a screw fixing post is spared, and the volume and weight thereof are further reduced. This is advantageous for miniaturization and light-weight design of the antenna apparatus 200, and also reduces an impact of components such as a metal screw on performance of the antenna apparatus. In addition, the structure of the ultrasonic connection is tightly integrated, and has good drop resistance.

According to the exemplary embodiments of the present disclosure, the ultrasonic wire 2112 is integrated to the first housing 211, and a material of the ultrasonic wire 2112 is the same as that of the first housing 211 and the second housing 212, such as polybutene (PB) or polycarbonate (PC).

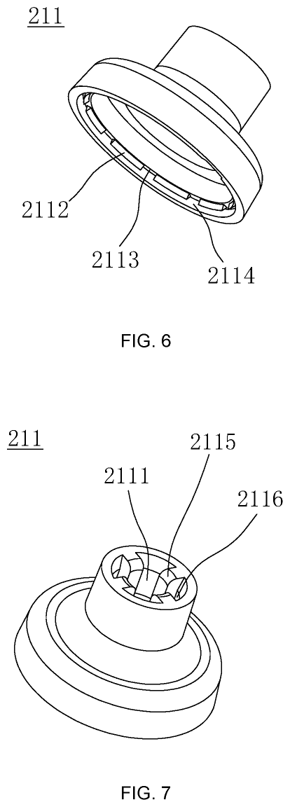

Structures of the first housing 211 and the second housing 212 may be designed based on a requirement. For example, in an exemplary embodiment, with reference to FIG. 3 to FIG. 6, the first housing 211 may be provided with a first connecting surface 2113 and a second connecting surface 2114, the first connecting surface 2113 intersects with the second connecting surface 2114, and the ultrasonic wire 2112 is provided on the first connecting surface 2113. Correspondingly, the flange 2121 may include a third connecting surface 21211 and a fourth connecting surface 21212, and the third connecting surface 21211 intersects with the fourth connecting surface 21212. According to exemplary embodiments of the present disclosure, the ultrasonic wire 2112 is fixedly connected to the third connecting surface 21211 by ultrasonic means, and the second connecting surface 2114 abuts against the fourth connecting surface 21212. Tight connection for covering can be obtained between the first housing 211 and the second housing 212 through the engagement between the ultrasonic wire 2112 and the third connecting surface 21211 and the engagement between the second connecting surface 2114 and the fourth connecting surface 21212. This prevents moisture, dust, or the like from entering the accommodating space 24 through a joint between the first housing 211 and the second housing 212, protects the antenna 23 effectively, and prevents performance of the antenna 23 from being affected.

According to the exemplary embodiments of the present disclosure, the first connecting surface 2113, the second connecting surface 2114, the third connecting surface 21211, and the fourth connecting surface 21212 are all ring-shape surfaces. In some examples, there are a plurality of ultrasonic wires 2112, and the plurality of ultrasonic wires 2112 are evenly spaced apart along a circumferential direction of the first connecting surface 2113. In some examples, the ultrasonic wires 2112 are ring-shaped, and a central axis of a ring in which the ultrasonic wires 2112 are located and a central axis of a ring in which the first connecting surface 2113 is located are coaxial.

In some examples, the flange 2121 is ring-shape, and the fourth connecting surface 21212 is an outer sidewall of the flange 2121. Correspondingly, the second connecting surface 2114 is ring-shape, and the second connecting surface 2114 is sleeved over the fourth connecting surface 21212.

In some examples, the first connecting surface 2113 and the second connecting surface 2114 are perpendicular to each other, and the third connecting surface 21211 and the fourth connecting surface 21212 are perpendicular to each other. It may be understood that an angle between the first connecting surface 2113 and the second connecting surface 2114 may also be another angle (not 90 degrees), as long as the first connecting surface 2113 and the second connecting surface 2114 are not on a same plane; and an angle between the third connecting surface 21211 and the fourth connecting surface 21212 may also be another angle (not 90 degrees), as long as the third connecting surface 21211 and the fourth connecting surface 21212 are not on a same plane. In some examples, the angle between the third connecting surface 21211 and the fourth connecting surface 21212 and the angle between the first connecting surface 2113 and the second connecting surface 2114 are complementary to each other, which facilitates the engagement between the first housing 211 and the second housing 212.

Further, the first housing 211 may be further provided with a fifth connecting surface (not shown), where the fifth connecting surface intersects with the second connecting surface 2114, and the second connecting surface 2114 is disposed between the first connecting surface 2113 and the fifth connecting surface; correspondingly, the second housing 212 may be further provided with a sixth connecting surface, where the sixth connecting surface intersects with the fourth connecting surface 21212, and the fourth connecting surface 21212 is disposed between the third connecting surface 21211 and the sixth connecting surface. According to the exemplary embodiments of the present disclosure, the first connecting surface 2113 and the third connecting surface 21211 are disposed near the accommodating space 24, and the fifth connecting surface and the sixth connecting surface are disposed near an outer side of the housing 21. When the first housing covers and engages with the second housing, the fifth connecting surface is opposite to the sixth connecting surface. In some examples, as the first housing covering and engaging with the second housing, the fifth connecting surface abuts against the sixth connecting surface. This further achieves tight engagement between the first housing 211 and the second housing 212, and prevents a foreign substance from entering the accommodating space 24.

In some exemplary embodiments, the fifth connecting surface and the second connecting surface 2114 are perpendicular to each other, and the sixth connecting surface and the fourth connecting surface 21212 are perpendicular to each other. It may be understood that an angle between the fifth connecting surface and the second connecting surface 2114 may also be another angle (not 90 degrees), as long as the fifth connecting surface and the second connecting surface 2114 are not on a same plane; and an angle between the sixth connecting surface and the fourth connecting surface 21212 may also be another angle (not 90 degrees), as long as the sixth connecting surface and the fourth connecting surface 21212 are not on a same plane. In some examples, the angle between the fifth connecting surface and the second connecting surface 2114 and the angle between the sixth connecting surface and the fourth connecting surface 21212 are complementary to each other.

A mode of the engagement between the mounting hole 2111 and the coaxial cable 1 may be designed based on a requirement. For example, in an exemplary embodiment, with reference to FIG. 7, a plurality of first protruding ribs 2115 that are spaced apart and a plurality of grooves 2116 that are formed between the first protruding ribs 2115 may be disposed on a sidewall of the mounting hole 2111. It may be understood that a quantity of the grooves 2116 is the same as a quantity of the first protruding ribs 2115. According to the exemplary embodiments of the present disclosure, the second insulating layer 14 of the coaxial cable 1 and the first protruding ribs 2115 are in fixed engagement. The coaxial cable 1 may be positioned by the first protruding ribs 2115, so that the coaxial cable 1 is located on or close to a central axis of the mounting hole 2111 as much as possible. In addition, engagement between the first protruding ribs 2115 and the second insulating layer 14 can enhance the reliability of a connection between the coaxial cable 1 and the mounting hole 2111.

According to the exemplary embodiments of the present disclosure, the plurality of first protruding ribs 2115 are arranged at intervals along a circumferential direction of the mounting hole 2111. In some examples, the plurality of first protruding ribs 2115 are arranged at even intervals along the circumferential direction of the mounting hole 2111. Further, an extension direction of the first protruding rib 2115 is an axial direction of the mounting hole 2111. In addition, the quantity of the first protruding ribs 2115 may be selected based on a reliability requirement for the connection between the coaxial cable 1 and the mounting hole 2111.

In some examples, the first protruding ribs 2115 are integrated with an inner sidewall of the mounting hole 2111.

To prevent the cable core 11 from stress and wear caused by contact between the cable core 11 and the mounting hole 2111 and better protect the cable core 11 accommodated in the accommodating space 24, in some examples, in the axial direction of the mounting hole 2111, the length of a portion of the mounting hole 2111 engaged with the second insulating layer 14 is greater than or equal to a half of an axial length of the mounting hole 2111.

In a feasible implementation, the length of the portion of the mounting hole 2111 engaged with the second insulating layer 14 is the axial length of the mounting hole 2111, that is, the mounting hole 2111 is merely engaged with the second insulating layer 14, but is not in contact with the cable core 11 and the first insulating layer 12 at the corresponding end. In another feasible implementation, the length of the portion of the mounting hole 2111 engaged with the second insulating layer 14 is equal to a length of a portion of the mounting hole 2111 engaged with the shielding layer 13, that is, one half of the mounting hole 2111 is engaged with the second insulating layer 14, and the other half thereof is engaged with the shielding layer 13. This can also prevent the mounting hole 2111 from contacting the cable core 11 and the first insulating layer 12 at the corresponding end.

Further, the groove(s) 2116 is filled with a filling medium for fixing the second insulating layer 14. The filling medium can penetrate the groove 2116 and the first insulating layer 12 or the first insulating layer 12 and the shielding layer 13. This further enhances the reliability of a connection between the second insulating layer 14 and the mounting hole 2111 and the performance thereof in bending resistance (or torsion resistance), drop resistance, and tension resistance. In addition, the filling medium may penetrate the groove 2116 and the second insulating layer 14 of the coaxial cable 1 or the second insulating layer 14 and the shielding layer 13. In the case where the antenna apparatus 200 receives an external force such as bending, torsion, or pressure, it is ensured that, at a joint between the coaxial cable 1 and the mounting hole 2111, it is always the second insulating layer 14 and the housing 21, or the second insulating layer 14, the shielding layer 13, and the housing 21 that suffers stress and wear is always. Therefore, the cable core 11 can be prevented from stress and wear, and the cable core 11 is effectively protected. In addition, in this manner, the costs are low, the process is controllable, and the yield is high.

According to the exemplary embodiments of the present disclosure, after one end of the coaxial cable 1 is disposed through the mounting hole 2111, the groove 2116 is filled with the filling medium, so that the filling medium can fully penetrate the second insulating layer 14, such that the coaxial cable 1 can be connected securely in the mounting hole 2111. The filling medium may be fixing glue or another medium having a fixing function.

It may be understood that the mounting hole 2111 may also have another structure. For example, the inner sidewall of the mounting hole 2111 may be a smooth surface, the second insulating layer 14 of the coaxial cable 1 is connected with the mounting hole 2111 through insertion, and a gap between the second insulating layer 14 and the inner sidewall of the mounting hole 2111 is filled with a filling medium. This enhances reliability of the connection between the second insulating layer 14 and the mounting hole 2111.

After the coaxial cable 1 is inserted in the accommodating space 24, to facilitate the engagement between the cable core 11 and the pad 231 in the accommodating space 24, the pad 231 is disposed opposite to the mounting hole 2111 According to the exemplary embodiments of the present disclosure.

The mode of the engagement between the pad 231 and the cable core 11 may also be designed based on a requirement. For example, in some exemplary embodiments, the pad 231 may include a fixing hole 2311 and a welding hole 2312 in communication with the fixing hole 2311; the fixing hole 2311 is located between the mounting hole 2111 and the welding hole 2312, and a size of the fixing hole 2311 is greater than a size of the welding hole 2312. According to the exemplary embodiments of the present disclosure, the cable core 11 is inserted in the welding hole 2312, the cable core 11 is connected to the welding hole 2312 by welding/soldering, and the first insulating layer 12 is inserted in the fixing hole 2311. The engagement between the cable core 11 and the welding hole 2312 and engagement between the first insulating layer 12 and the fixing hole 2311 can enhance secure connectivity between the pad 231 and the coaxial cable 1, therefore enhance reliability of the electrical connection between the coaxial cable 1 and the antenna 23.

It may be understood that in other embodiments, the pad 231 may include only the welding hole 2312, but does not include the fixing hole 2311, where the cable core 11 is inserted in the welding hole 2312, and the cable core 11 is connected to the welding hole 2312 by welding/soldering.

In the following embodiment, the pad 231 includes the welding hole 2312 and the fixing hole 2311.

The welding hole 2312 and the fixing hole 2311 form a through hole. The cable core 11 is disposed through the welding hole 2312 and is exposed from the welding hole 2312. This improves reliability of a fixed connection between the cable core 11 and the welding hole 2312, and therefore enhances reliability of the electrical connection between the coaxial cable 1 and the antenna 23.

According to the exemplary embodiments of the present disclosure, the welding hole 2312 and the fixing hole 2311 are coaxial holes; this is advantageous for the engagement between the coaxial cable 1 and the pad 231.

A reflow soldering process may be used to solder between the cable core 11 and the welding hole 2312, or another welding/soldering process may be used for welding/soldering.

In some examples, a gap between the first insulating layer 12 and the fixing hole 2311 is filled with a filling medium, to ensure reliability and consistency of the electrical connection between the coaxial cable 1 and the antenna 23. In addition, the filling medium between the first insulating layer 12 and the fixing hole 2311 may further absorb some impacts generated by external drops and collisions. The filling medium may be fixing glue or another medium having a fixing function.

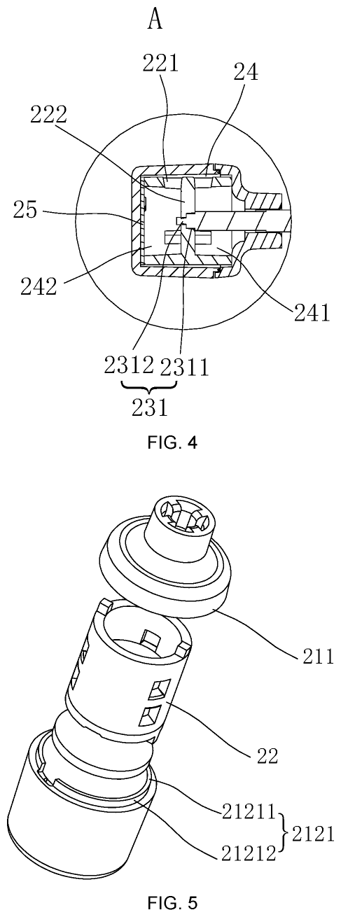

To further enhance reliability of a connection between the coaxial cable 1 and the pad 231. In some examples, as shown in FIG. 3 and FIG. 4, the shielding layer 13 covers the fixing hole 2311, and the shielding layer 13 can be fixed to the antenna support 22 via the filling medium.

Referring to FIG. 5, the antenna support 22 may include a main body portion 221 and a sub-support 222, where the main body portion 221 is ring-shape, the sub-support 222 is disposed in the main body portion 221 and fixedly connected to the main body portion 221, and the pad 231 is disposed on the sub-support 222. It may be understood that the antenna support 22 may also be designed with another structure, and specific the structure is not limited herein.

According to the exemplary embodiments of the present disclosure, the sub-support 222 is disposed opposite to the mounting hole 2111, to facilitate the connection between the coaxial cable 1 and the pad 231.

In some examples, one end of the main body portion 221 is disposed facing the first housing 211, and the other end of the main body portion 221 is disposed facing the second housing 212. According to the exemplary embodiments of the present disclosure, a gap exists between the main body portion 221 and the first housing 211, a gap exists between the main body portion 221 and the second housing 212, and a gap also exists between an outer sidewall of the main body portion 221 and the first housing 211 and/or the second housing 212. The gap design prevents the antenna support 22 from contacting the housing 21. Even if the antenna apparatus 200 drops and receives an impact, the impact on the housing 21 does not affect the antenna support 22. The antenna apparatus 200 has high drop resistance and high reliability. The antenna apparatus 200 is applicable to a device that is used under a harsh operating condition, such as an unmanned aerial vehicle.

According to the exemplary embodiments of the present disclosure, the sub-support 222 divides the main body portion 221 into two portions: one end (which may be referred to as a first end) of the main body portion 221 that faces the first housing 211, and an end (which may be referred to as a second end) of the main body portion 221 that faces the second housing 212.

Further, in some exemplary embodiments, a cushioning layer 25 is provided between the second housing 212 and the end of the main body portion 221 that faces the second housing 212, to prevent the antenna support 22 from contacting the second housing 212. In addition, the cushioning layer 25 can cushion an external force received by the second housing 212, and weaken an impact of the external force on the antenna support 22. Specifically, the cushioning layer 25 may be disposed between the second housing 212 and an end portion of the end of the main body portion 221 that faces the second housing 212.

The cushioning layer 25 may be a foam layer, or may be another flexible cushioning layer.

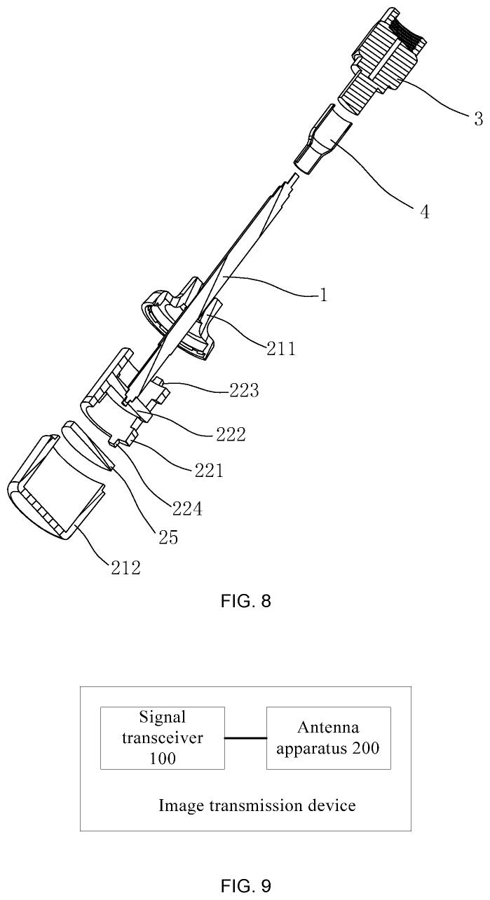

In some examples, referring to FIG. 8, a second protruding rib 223 may be provided at an end portion of the end of the main body portion 221 that faces the first housing 211, to reduce a contact area between the first housing 211 and the antenna support 22 and weaken an external force transferred by the first housing 211 to the main body portion 221. In some examples, the end portion of the end of the main body portion 221 that faces the first housing 211 is a flat surface.

Still referring to FIG. 8, a third protruding rib 224 may be at the end portion of the end of the main body portion 221 that faces the second housing 212, to reduce a contact area between the second housing 212 and the antenna support 22 and weaken an external force transferred by the second housing 212 to the main body portion 221. In some examples, the end portion of the end of the main body portion 221 that faces the second housing 212 is a flat surface.

In the embodiments shown in FIG. 1, FIG. 5 and FIG. 8, the second protruding rib 223 is disposed at the end portion of the end of the main body portion 221 that faces the first housing 211, and the third protruding rib 224 is disposed at the end portion of the end of the main body portion 221 that faces the second housing 212.

As shown in FIG. 4, a first cavity 241 may be formed between and enclosed by the sub-support 222, the first housing 211, and the end of the main body portion 221 that faces the first housing 211; a second cavity 242 is formed between and enclosed by the sub-support 222, the second housing 212, and the end of the main body portion 221 that faces the second housing 212. In some examples, the first cavity 241 is filled with a filling medium, and the filling medium may be fixing glue or another medium having a fixing function. The first cavity 241 is filled with the filling medium, and in a process in which the antenna apparatus 200 drops and receives an impact, the filling medium in the first cavity 241 may absorb a part of the impact, and therefore effectively protect the antenna support 22.

With reference to FIG. 1 to FIG. 3, and FIG. 8, the antenna apparatus 200 may further include a connector 3. The connector 3 is configured to connect to an external signal device. The end of the coaxial cable 1 that is exposed from the housing 21 is inserted in the connector 3, and the corresponding end of the cable core 11 is welded to the connector 3 to implement an electrical connection between the coaxial cable 1 and the connector 3. To be specific, one end of the cable core 11 of the coaxial cable 1 is electrically connected to the pad 231 in the housing 21, the other end of the cable core 11 of the coaxial cable 1 is electrically connected to the connector 3, and the antenna 23 and the connector 3 are connected by the coaxial cable 1.

According to the exemplary embodiments of the present disclosure, one end of the cable core 11 is fixedly connected to the pad 231 to implement the electrical connection between the coaxial cable 1 and the antenna 23; and the other end of the cable core 11 is fixedly connected to the connector 3 to implement the electrical connection between the coaxial cable 1 and the connector 3.

Referring to FIG. 3, the connector 3 may include a connecting hole 31, and the cable core 11 at the corresponding end (that is, the end of the coaxial cable 1 that is exposed from the housing 21) is inserted in the connecting hole 31, so that the cable core 11 is electrically connected to the connecting hole 31 and that the electrical connection between the coaxial cable 1 and the connector 3 is implemented. In some examples, the cable core 11 is welded with the connecting hole 31 so as to enhance secure connectivity between the cable core 11 and the connecting hole 31, thereby improving reliability of the electrical connection between the coaxial cable 1 and the connector 3.

Further, the antenna apparatus 200 may further include a ring-shaped rivet member 4; one end of the rivet member 4 is sleeved over and fixed to the connector 3, and the other end of the rivet member 4 is sleeved over and fixed to the coaxial cable 1; a part of an inner sidewall of the rivet member 4 abuts against the second insulating layer 14. Through the rivet member 4, a joint between the coaxial cable 1 and the connector 3 has high performance in bending resistance (or torsion resistance), drop resistance, and tension resistance. Therefore, even if the antenna apparatus 200 suffers bending, torsion, pressure, or the like, the rivet member 4 can ensure that what suffers stress and wear at the joint between the coaxial cable 1 and the connector 3 is always the second insulating layer 14 and the connector 3, or the second insulating layer 14, the shielding layer 13 and the connector 3. Therefore, the cable core 11 is prevented from stress and wear, and the cable core 11 is effectively protected.

Referring to FIG. 3 again, the connector 3 may include a first connecting end 32 and a second connecting end 33, where the first connecting end 32 is configured to connect to the coaxial cable 1, and the second connecting end 33 is configured to connect to an external device. In some examples, the connecting hole 31 is an electrical connecting hole 31, and is electrically connected to the second connecting end 33. Specifically, one end of the rivet member 4 is sleeved over and fixed to the first connecting end 32, and the other end of the rivet member 4 is sleeved over and fixed to the coaxial cable 1.

A material of the rivet member 4 may be copper, or may be another material featuring abrasion resistance, bending resistance, and drop resistance, so that the joint between the coaxial cable 1 and the connector 3 is effectively protected. An abutting length between the rivet member 4 and the coaxial cable 1 (an axial length of the coaxial cable 1) may be specifically designed to ensure that a shortest abutting length can achieve a large bending degree and a large range of motion at the joint between the coaxial cable 1 and the connector 3.

The connector 3 may be an SMA connector, an MMCX connector, or an IPEX connector, or may be another type of connector. By means of setting the connector 3 to be different types of connectors, the antenna apparatus 200 becomes applicable to different types of external signal devices.

The antenna apparatus 200 may be applied to an unmanned aerial vehicle or another device capable of transmitting an electromagnetic wave signal.

According to exemplary embodiments with reference to FIG. 1 to FIG. 8, the antenna apparatus 200 may include a coaxial cable 1 and an antenna assembly 2. The coaxial cable 1 may include a cable core 11, a first insulating layer 12 wrapping over the cable core 11, a shielding layer 13 wrapping over the first insulating layer 12, and a second insulating layer 14 wrapping over the shielding layer 13. The antenna assembly 2 includes a housing 21, an antenna support 22, and an antenna 23 provided on the antenna support 22 through LDS. The antenna 23 may include a pad 231 disposed on the antenna support 22. The housing 21 is provided with a mounting hole 2111 and an accommodating space 24, the mounting hole 2111 is in communication with the accommodating space 24, the antenna support 22 is accommodated in the accommodating space 24, and the antenna support 22 is not in contact with an inner sidewall of the housing 21. The coaxial cable 1 is disposed through and fixed in the mounting hole 2111, one end of the coaxial cable 1 is accommodated in the accommodating space 24, the other end of the coaxial cable 1 is exposed from the housing 21, and a corresponding end of the cable core 11 is fixedly connected to the pad 231 to implement an electrical connection between the coaxial cable 1 and the antenna 23.

In the antenna apparatus 200, the antenna support 22 is not in contact with the inner sidewall of the housing 21; in addition, the pad 231 is fixedly connected to the corresponding end of the cable core 11 to fix the antenna support 22 to the coaxial cable 1 and implement an electrical connection between the antenna 23 and the coaxial cable 1. In this way, the pad 231 in the housing 21 can be protected. Even if the housing 21 receives an external impact force such as a drop, an impact, or a collision, the pad 231 is not affected by the impact force. This improves drop resistance and reliability of the antenna apparatus 200. The antenna apparatus 200 may be applied to a device that is used under a harsh operating condition, such as an unmanned aerial vehicle.

A structure of the antenna apparatus 200 the exemplary embodiments with reference to FIG. 1 to FIG. 8 may be similar to that of the antenna apparatus in the exemplary embodiments with reference to FIG. 1 to FIG. 4, and will not be described herein.

The antenna apparatus 200 may be applied to an unmanned aerial vehicle or another device capable of transmitting an electromagnetic wave signal.

The exemplary embodiments in FIG. 9 of the present disclosure provide an image transmission device, where the image transmission device may include a signal transceiver 100 and an antenna apparatus 200. The signal transceiver 100 can transmit and receive electromagnetic wave signals. The antenna apparatus 200 can cooperate with the signal transceiver 100 to implement transmission and reception of electromagnetic wave signals.

The antenna apparatus 200 may be the antenna apparatus 200 in the foregoing exemplary embodiments with reference to FIG. 1 to FIG. 4, or may be the antenna apparatus 200 in the foregoing exemplary embodiments with reference to FIG. 1 to FIG. 8.

Specifically, the antenna apparatus 200 is electrically connected to the signal transceiver 100 through a connector 3. The image transmission device may be applied to an unmanned aerial vehicle. The signal transmission links of the image transmission device may include: an image captured by the unmanned aerial vehicle->antenna 23->coaxial cable 1->connector 3->signal transceiver 100; and a control signal generated by the signal transceiver 100->connector 3->coaxial cable 1->antenna 23->unmanned aerial vehicle.

Further, the unmanned aerial vehicle may be a traversing vehicle dedicated to racing or an unmanned racing vehicle. The traversing vehicle generally uses an FPV (first-person perspective), has a high flight speed, and is generally subject to a drop, a collision, a crash, or the like as the traversing vehicle is used for racing. Therefore, high drop resistance and reliability of both the image transmission device and the antenna apparatus carried on the traversing vehicle should be ensured, so that the traversing vehicle can be used under a harsh operating condition.

It should be noted that the relational terms such as first and second in this specification are used only to differentiate an entity or operation from another entity or operation, and do not require or imply any actual relationship or sequence between these entities or operations. The terms “comprise”, “include”, or any other variant thereof are intended to cover a non-exclusive inclusion, so that a process, a method, an article, or a device that includes a list of elements not only includes those elements but may also include other elements that are not explicitly listed, or may further include elements inherent to the process, method, article, or device. In absence of more constraints, an element preceded by “includes a/an . . . ” does not preclude existence of other identical elements in the process, method, article, or device that includes the element.

The antenna apparatus and the image transmission device having the antenna apparatus provided by the embodiments of the present disclosure are described in detail above. Although the principles and implementations of the present disclosure are described by using specific examples in this specification, the description of the embodiments is intended only to help understand the method and core idea of the present disclosure. In addition, based on the idea of the present disclosure, a person of ordinary skill in the art may make modifications on the specific implementations and the application scope. Therefore, content of this specification shall not be construed as a limitation on the present disclosure.

What is claimed is:

1. An antenna apparatus, comprising:
a coaxial cable including a cable core, a first insulating layer wrapping over the cable core, a shielding layer wrapping over the first insulating layer, and a second insulating layer wrapping over the shielding layer; and
an antenna assembly including:
a housing, including a first housing and a second housing, wherein an accommodating space is formed by the first housing covering and engaging with the second housing,
an antenna support, accommodated in the accommodating space, and
an antenna, disposed on the antenna support through laser-direct-structuring (LDS), and including a pad disposed on the antenna support,
wherein
the second housing includes a flange,
the first housing connects to the flange and includes a mounting hole in communication with the accommodating space,
the coaxial cable is disposed through and fixed in the mounting hole,
one end of the coaxial cable is accommodated in the accommodating space, and the other end of the coaxial cable is exposed from the housing,
wherein
a corresponding end of the cable core couples with the pad to form an electrical connection between the coaxial cable and the antenna.

2. The antenna apparatus according to claim 1, wherein the first housing includes:
a first connecting surface having a welded wire disposed on the first connecting surface; and
a second connecting surface intersecting with the first connecting surface, and
the flange includes:
a third connecting surface connected to the welded wire, and
a fourth connecting surface intersected with the third connecting surface and abut against the second connecting surface.

3. The antenna apparatus according to claim 1, wherein a sidewall of the mounting hole includes a plurality of first protruding ribs spaced apart and in fixed coupling with the second insulating layer of the coaxial cable; and
a plurality of grooves formed between the plurality of first protruding ribs.

4. The antenna apparatus according to claim 3, wherein the plurality of grooves is filled with a filling medium to fix the second insulating layer.

5. The antenna apparatus according to claim 3, wherein in an axial direction of the mounting hole, a length of a portion of the mounting hole engaged with the second insulating layer is greater than or equal to a half of an axial length of the mounting hole.

6. The antenna apparatus according to claim 1, wherein the pad is arranged opposite to the mounting hole and includes a fixing hole and a welding hole in communication with the fixing hole;
the fixing hole is arranged between the mounting hole and the welding hole, and a size of the fixing hole is greater than a size of the welding hole;
the cable core is inserted in the welding hole and connected to the welding hole by welding, and the first insulating layer is inserted in the fixing hole.

7. The antenna apparatus according to claim 6, wherein a filling medium is filled between the first insulating layer and the fixing hole.

8. The antenna apparatus according to claim 7, wherein the shielding layer covers the fixing hole, and the shielding layer is fixed to the antenna support via the filling medium.

9. The antenna apparatus according to claim 1, wherein the antenna support includes a ring-shaped main body portion and a sub-support disposed in and fixedly connected to the main body portion, and
the pad is disposed on the sub-support.

10. The antenna apparatus according to claim 9, wherein one end of the main body portion is arranged to face the first housing;
the other end of the main body portion is disposed to face the second housing;
a gap exists between the main body portion and the first housing;
a gap exists between the main body portion and the second housing; and
a gap exists between an outer sidewall of the main body portion and at least one of the first housing or the second housing.

11. The antenna apparatus according to claim 10, wherein the main body portion includes at least one of:
an end portion of the end of the main body portion that faces the first housing includes a second protruding rib or is a flat surface; or
an end portion of the end of the main body portion that faces the second housing includes a third protruding rib or is a flat surface.

12. The antenna apparatus according to claim 10, wherein a cushioning layer is disposed between the second housing; and
the end of the main body portion that faces the second housing.

13. The antenna apparatus according to claim 10, wherein a first cavity is formed between and enclosed by the sub-support, the first housing, and the end of the main body portion that faces the first housing;
a second cavity is formed between and enclosed by the sub-support, the second housing, and the end of the main body portion that faces the second housing; and
the first cavity is filled with a filling medium.

14. The antenna apparatus according to claim 1, further comprising:
a connector to connect to an external signal device,
wherein the end of the coaxial cable that is exposed from the housing is inserted in the connector, and
the corresponding end of the cable core connects to the connector to form an electrical connection between the coaxial cable and the connector.

15. The antenna apparatus according to claim 14, further comprising:
a ring-shaped rivet member,
wherein one end of the rivet member is sleeved over and fixed to the connector, and another end of the rivet member is sleeved over and fixed to the coaxial cable, and
a part of an inner sidewall of the rivet member abuts against the second insulating layer.

16. The antenna apparatus according to claim 14, wherein the connector is an SMA connector, an MMCX connector, or an IPEX connector.

17. An image transmission device, comprising:
a signal transceiver; and
an antenna apparatus in cooperation with the signal transceiver to transmit and receive electromagnetic wave signals;
the antenna apparatus including:
a coaxial cable including a cable core, a first insulating layer wrapping over the cable core, a shielding layer wrapping over the first insulating layer, and a second insulating layer wrapping over the shielding layer, and
an antenna assembly including:
a housing, including a first housing and a second housing, wherein an accommodating space is formed by the first housing covering and engaging with the second housing,
an antenna support accommodated in the accommodating space, and
an antenna, disposed on the antenna support through laser-direct-structuring (LDS), and including a pad disposed on the antenna support,
wherein
the first housing connects to the flange and includes a mounting hole in communication with the accommodating space,
the coaxial cable is disposed through and fixed in the mounting hole,
one end of the coaxial cable is accommodated in the accommodating space, and the other end of the coaxial cable is exposed from the housing,
wherein
a corresponding end of the cable core couples with the pad to form an electrical connection between the coaxial cable and the antenna.

18. An antenna apparatus, comprising:
a coaxial cable including a cable core, a first insulating layer wrapping over the cable core, a shielding layer wrapping over the first insulating layer, and a second insulating layer wrapping over the shielding layer; and
an antenna assembly including:
a housing, including a mounting hole and an accommodating space in communication with the mounting hole,
an antenna support accommodated in the accommodating space and not in contact with an inner sidewall of the housing, and
an antenna, disposed on the antenna support through laser-direct-structuring (LDS), and including a pad disposed on the antenna support,
wherein
the coaxial cable is disposed through and fixed in the mounting hole,
one end of the coaxial cable is accommodated in the accommodating space, another end of the coaxial cable is exposed from the housing, and a corresponding end of the cable core is fixedly connected to the pad to form an electrical connection between the coaxial cable and the antenna.

19. The antenna apparatus according to claim 18, wherein the housing includes a first housing and a second housing;
the accommodating space is formed by closing the first housing and the second housing together, the mounting hole is arranged in the first housing,
a welded wire is on the first housing;
a flange is in a corresponding position on the second housing; and
the welded wire is connected to the flange to fix the first housing to the second housing.

20. The antenna apparatus according to claim 19, wherein the first housing includes:
a first connecting surface having the welded wire disposed on the first connecting surface, and
a second connecting surface intersected with the first connecting surface,
the flange includes:
a third connecting surface welded with the welded wire, and
a fourth connecting surface intersected with the third connecting surface and abuts against the second connecting surface.
